(19) United States
(12) Patent Application Publication
(10) Pub. No.: US 2026/0028955 A1
(43) Pub. Date: Jan. 29, 2026

(54) DAMPING ASSEMBLY AND REWIND STARTER

(71) Applicant: BRP-ROTAX GMHB & CO. KG, Gunskirchen (AT)

(72) Inventors: Roland ENNSMANN, Gunskirchen (AT); Gerold JEDINGER, Geboltskirchen (AT); Christian BERGER, Meggenhofen (AT)

(21) Appl. No.: 19/273,322

(22) Filed: Jul. 18, 2025

Related U.S. Application Data
(60) Provisional application No. 63/675,968, filed on Jul. 26, 2024.

(51) Int. Cl. F02N 3/02; F16F 1/373; F16F 15/08

(52) U.S. Cl. CPC F02N 3/02; F16F 1/3732; F16F 15/08; F16F 2224/025; F16F 2230/0005; F16F 2230/10

(57) ABSTRACT

A damping assembly, which is for a rewind starter of an engine, includes a cover housing, at least one damper, a cover mount and a retaining member. The cover housing is configured to connect to a housing of the engine, and includes a housing base defining an aperture, and a housing wall extending axially from the housing base. The housing wall at least partially surrounds the housing base. The at least one damper is connected to the housing base, and extends at least partially around the aperture. The cover mount is connected to the at least one damper, at least partially extends through the aperture, at least partially covers the aperture, and has a spindle configured to operatively connect to part of the rewind starter. The retaining member retains the cover housing, the at least one damper and the cover mount together.

### CROSS-REFERENCE TO RELATED APPLICATION

The present application claims priority to U.S. Provisional Patent Application No. 63/675,968, filed Jul. 26, 2024 entitled “Damping Assembly and Rewind Starter”, which is incorporated by reference herein in its entirety.

### TECHNOLOGICAL FIELD

The present technology relates to damping assemblies for rewind starters, and rewind starters.

### BACKGROUND

Some engines are equipped with rewind starters, which can be used to pull-start these engines.

Rewind starters are conventionally mounted directly to the housings of their engines. Thus, when the engines are running, conventional rewind starters can be subjected to a lot of vibrations. These vibrations can lead to premature wear of some elements of the rewind starters.

Additionally, some engines can run in reverse. In such engines, inappropriate use of conventional rewind starters, such as trying to pull-start the engine when the engine is already running in a reverse direction, can damage the rewind starters.

Thus, there is a desire for a rewind starter that can reduce the impact of vibrations and reduce likelihood of damage when incorrectly used.

### SUMMARY

It is an object of the present technology to ameliorate at least some of the inconveniences present in the prior art.

According to one aspect of the present technology, there is provided a damping assembly for a rewind starter of an engine. The damping assembly includes a cover, at least one damper, a cover mount, and a retaining member. The cover housing, which is configured to connect to a housing of the engine, includes a housing base defining an aperture, and a housing wall extending axially from the housing base. The housing wall at least partially surrounds the housing base. The at least one damper is connected to the housing base, and extends at least partially around the aperture. The cover mount is connected to the at least one damper, at least partially extends through the aperture, at least partially covers the aperture, and the cover mount has a spindle configured to operatively connect to part of the rewind starter. The retaining member retains the cover housing, the at least one damper and the cover mount together.

In some embodiments, at least one of the at least one damper is selectively connected to the housing base, and the cover mount is selectively connected to the at least one damper.

In some embodiments, the cover housing has housing connectors, and the at least one damper has damper connectors, each one of the damper connectors being engaged to a corresponding one of the housing connectors.

In some embodiments, each one of the housing connectors has a flange, and each one of the damper connectors defines a recess receiving the flange of a corresponding one of the housing connectors.

In some embodiments, the cover mount has mount connectors engaged with at least one of the at least one damper and the retaining member.

In some embodiments, the at least one damper has damper positioners, and the cover mount has mount positioners, each one of the mount positioners being engaged with a corresponding one of the damper positioners for positioning the at least one damper relative to the cover mount.

In some embodiments, the at least one damper is made of a resilient material.

In some embodiments, the resilient material is rubber.

In some embodiments, the at least one damper is two dampers.

In some embodiments, the at least one damper is a damping ring.

In some embodiments, the retaining member is a retaining ring.

In some embodiments, the retaining member is moveable between a retaining position, in which the cover housing, the at least one damper and the cover mount are retained together, and a non-retaining position, in which the cover housing, the at least one damper and the cover mount are free to be moved away from one another.

In some embodiments, the retaining member is moveable between the retaining position and the non-retaining position by rotation.

According to another aspect of the present technology, there is provided a rewind starter for an engine, the rewind starter including the damping assembly according to the above aspect or according to the above aspect and one or more of the above embodiments, a sheave, a rope, a recoil spring, a pawl and a lock lever. The sheave is rotationally connected to the spindle, and has a rest position. The rope is wound around the sheave. The recoil spring is operatively connected to the damping assembly and to the sheave. The recoil spring biases the sheave toward the rest position. The pawl is pivotally connected to the sheave. The pawl is pivotable about a pivot axis between engaged and disengaged positions. In the engaged position, the pawl is configured to be drivingly engaged to a flywheel of the engine. In the disengaged position, the pawl is configured to be drivingly disengaged from the flywheel of the engine. The lock lever is operatively connected to the spindle, and is configured to cause the pawl to move between the engaged position and the disengaged position.

In some embodiments, the recoil spring has a plurality of windings and the rewind starter further comprises a holder holding the recoil spring. The holder includes a holder base and a holder wall. The holder base defines a central aperture for receiving the spindle therethrough. The holder wall extends axially from the holder base, and at least partially surrounds the holder base. The guiding projection extends axially from the holder base, is positioned axially between the holder wall and the central aperture, between two windings of the plurality of windings.

In some embodiments, the holder is connected to at least one of the cover mount and the at least one damper.

In some embodiments, the two windings of the plurality of windings are a radially outermost winding and a second radially outermost winding.

In some embodiments, the recoil spring has a radially outer end and a radially inner end, the holder wall defines a radially outer hooking portion, the radially outer end is connected to the radially outer hooking portion, and the radially inner end is connected to the sheave.

In some embodiments, in the disengaged position, the pawl is spaced from the flywheel, and the pawl is further moveable to a neutral position, in the neutral position the pawl is configured to be non-drivingly engageable to the flywheel.

In some embodiments, the neutral position is intermediate to the engaged position and to the disengaged position.

In some embodiments, the pawl has an arcuate edge, and with the pawl being in the neutral position, the arcuate edge is configured to slide over engaging portions of the flywheel.

According to another aspect of the present technology, there is provided a rewind starter for an engine, the rewind starter includes a cover, a sheave, a rope, a holder and a recoil spring. The cover is configured to connect to a housing of the engine, and has a spindle. The sheave is rotationally connected to the spindle, and has a rest position. The rope is wound around the sheave. The holder is connected to the cover, and includes a holder base and a holder wall. The holder base defines a central aperture for receiving the spindle therethrough, and the holder wall extends axially from the holder base. The holder wall at least partially surrounds the holder base. The guiding projection extends axially from the holder base and is positioned axially between the holder wall and the central aperture. The recoil spring has a plurality of windings, is received in the holder such that the guiding projection is positioned between two windings of the plurality of windings, and the recoil spring biases the sheave toward the rest position.

In some embodiments, the rewind starter further includes a pawl and a lock lever. The pawl is pivotally connected to the sheave, and is pivotable about a pivot axis between engaged and disengaged positions. In the engaged position, the pawl is configured to be drivingly engaged to a flywheel of the engine. In the disengaged position, the pawl is configured to be drivingly disengaged from the flywheel of the engine. The lock lever is operatively connected to the spindle, and is configured to cause the pawl to move between the engaged position and the disengaged position.

In some embodiments, the two windings of the plurality of windings are a radially outermost winding and a second radially outermost winding.

In some embodiments, the recoil spring has a radially outer end and a radially inner end, the holder wall defines a radially outer hooking portion, the radially outer end is connected to the radially outer hooking portion and the radially inner end is connected to the sheave.

According to another aspect of the present technology, there is provided a rewind starter for an engine. The rewind starter includes a cover, a sheave, a rope, a recoil spring, a pawl and a lock lever. The cover is configured to connect to a housing of the engine and has a spindle. The sheave is rotationally connected to the spindle, and has a rest position. The rope is wound around the sheave. The recoil spring is operatively connected to the sheave, and biases the sheave toward the rest position. The pawl is pivotally connected to the sheave. The pawl being pivotable about a pivot axis between an engaged position, a disengaged position and a neutral position. In the engaged position the pawl is configured to be drivingly engaged to a flywheel of the engine. In the disengaged position, the pawl is configured to be spaced from the flywheel of the engine. In the neutral position, the pawl is non-drivingly engageable to the flywheel of the engine. The lock lever is operatively connected to the spindle and is configured to cause the pawl to move between the engaged position, the disengaged position, and the neutral position.

In some embodiments, the neutral position is intermediate to the engaged position and the disengaged position.

In some embodiments, the pawl has an arcuate edge, and with the pawl being in the neutral position, the arcuate edge is configured to slide over engaging portions of the flywheel.

In the present application, expressions of the type: “at least one of A and B” should be understood to mean only A, only B, or both A and B.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, right side of an engine having a rewind starter according to an embodiment of the present technology;

FIG. 2 is a cross-sectional view taken along a lateral plane passing through a longitudinal center of the engine of FIG. 1, with a cylinder block, piston assemblies and cylinder heads of the engine being omitted;

FIG. 3 is an exploded perspective view taken from a top, front, left side of the rewind starter of FIG. 1;

FIG. 4 is a left side elevation view of the rewind starter of FIG. 1;

FIG. 5 is a cross-sectional perspective view of the rewind starter of FIG. 1, taken along line 5-5 of FIG. 4;

FIG. 6 is a left side elevation view of components of a damping assembly of the rewind starter of FIG. 1, the components including (from left to right) a cover housing, a damper, a cover mount, and a retaining ring;

FIG. 7 is a left side elevation view of the cover housing and the damper of FIG. 6 connected to one another;

FIG. 8 is a left side elevation view of the cover housing, the damper and the cover mount connected to one another;

FIG. 9 is a left side elevation view of the cover housing, the damper, the cover mount and the retaining ring connected to one another, with the retaining ring being in a non-retaining position;

FIG. 10 is a left side elevation view of the cover housing, the damper, the cover mount, and the retaining ring connected to one another, with the retaining ring being in a retaining position;

FIG. 11 is a left side elevation view of a holder and a recoil spring of the rewind starter of FIG. 1;

FIG. 12 is a right side elevation view of a flywheel of the engine of FIG. 1, with a pawl and a lock lever of the rewind starter of FIG. 1, with the pawl being in a disengaged position;

FIG. 13 is a right side elevation view of the flywheel, the pawl, and the lock lever of FIG. 12, with the pawl being in an engaged position;

FIG. 14 is a right side elevation view of the flywheel, the pawl, and the lock lever of FIG. 12, with the pawl being in a neutral position; and

FIGS. 15A and 15B are left side elevation views of alternative embodiments of the damper.

Unless indicated otherwise, the Figures are not drawn to scale.

### DETAILED DESCRIPTION

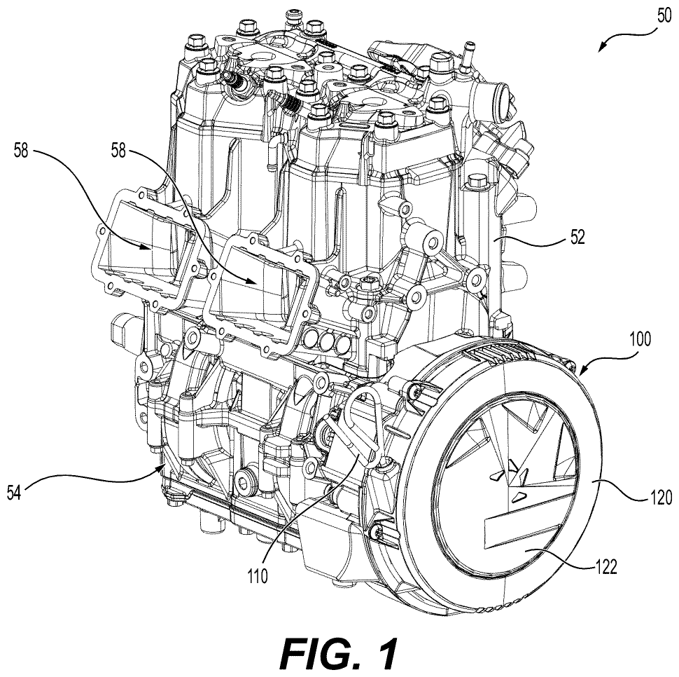

An engine 50 is shown in FIG. 1. The engine 50 is a two cylinder, two-stroke internal combustion engine. The engine 50 is configured to be used as an engine for a snowmobile, but it is contemplated that the engine 50 could be used in other applications such as an off-road all-terrain vehicle or a racing kart. It is contemplated that aspects of the present technology could also be used in other engines that can be started using a rewind starter, such as a lawn mower engine or a snowblower engine. It also contemplated that the configuration of the engine 50 could vary. For example, the number of cylinders of the engine 50 could vary.

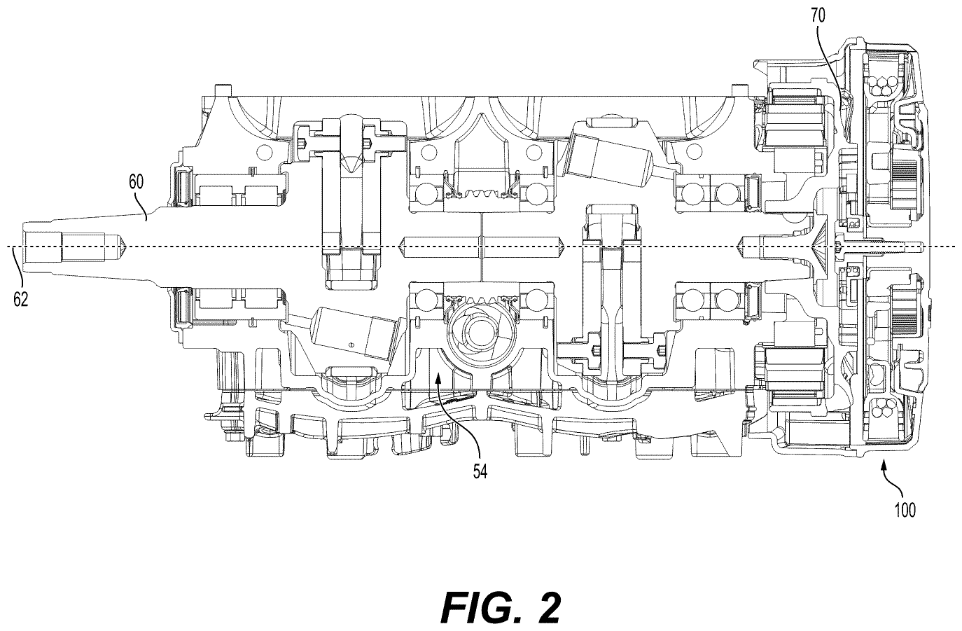

Referring to FIGS. 1 and 2, the engine 50 has an engine housing 52. The engine housing 52 has a crankcase portion 54, defines two cylinders (not shown in accompanying Figures) and has air intake ports 58 and exhaust ports (also not shown in accompanying Figures).

The engine 50 has a crankshaft 60 that is received in the crankcase portion 54. The crankshaft 60 is rotatable about an axis 62. The crankshaft 60 is operatively connected to two connecting rods (not shown), and each one of the connecting rods is positioned to be in part received in a respective one of the cylinders. Each one of the connecting rods has, at the end opposite to the crankshaft 60, a piston connected thereto.

In response to the crankshaft 60 rotating about the axis 62, the pistons move within the cylinders.

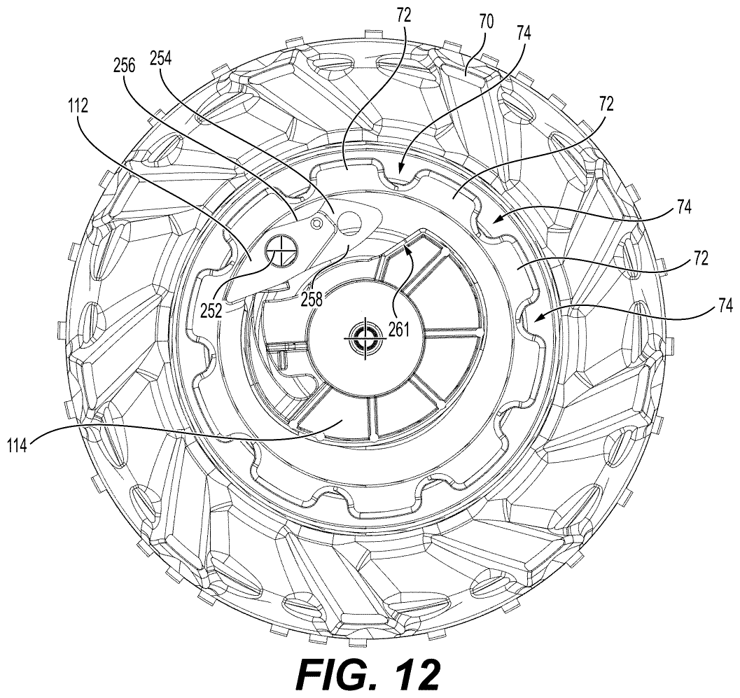

The engine 50 also includes a flywheel 70. The flywheel 70 is connected to an end of the crankshaft 60, such that in response to the crankshaft 60 rotating about the axis 62, the flywheel 70 also rotates about the axis 62. Similarly, in response to the flywheel 70 rotating about the axis 62, the crankshaft 60 also rotates about the axis 62. As best seen in FIGS. 12, 13 and 14, the flywheel 70 has flywheel engaging portions 72 that extend generally radially. The flywheel engaging portions 72 will henceforth be referred to as flywheel teeth 72. The flywheel 70 further defines a plurality of flywheel recesses 74. Each one of the flywheel recesses 74 is defined between two adjacent flywheel teeth 72.

Referring to FIGS. 1 to 3, the engine 50 also includes a rewind starter 100 in accordance with an embodiment of the present technology. The rewind starter 100 is operatively connected to the flywheel 70. The rewind starter 100 includes a damping assembly 102 that connects the rewind starter 100 to the engine housing 52. The rewind starter 100 also includes a holder 104 that is connected to the damping assembly 102 and a recoil spring 106 that is received in the holder 104. The rewind starter 100 further includes a sheave 108 that connected to the damping assembly 102, a rope 110 wound around the sheave 108, and a pawl 112 that is pivotally connected to the sheave 108. A handle (not shown) is connected to one end of the rope 110. As will be described below, the pawl 112 is configured to selectively engage with the flywheel 70. The rewind starter 100 also includes a lock lever 114 connected to the damping assembly 102.

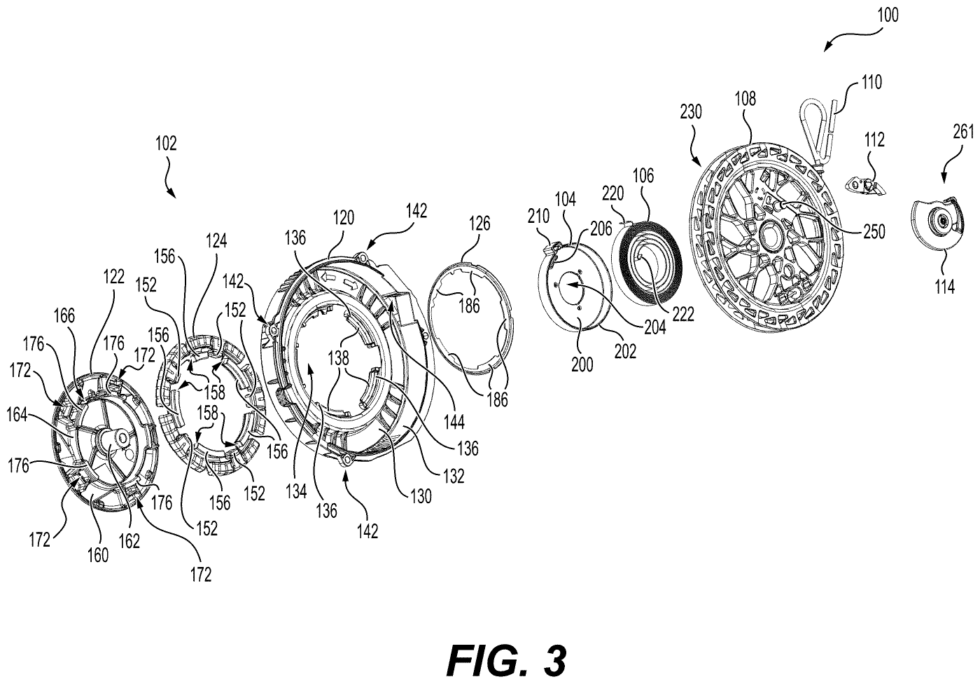

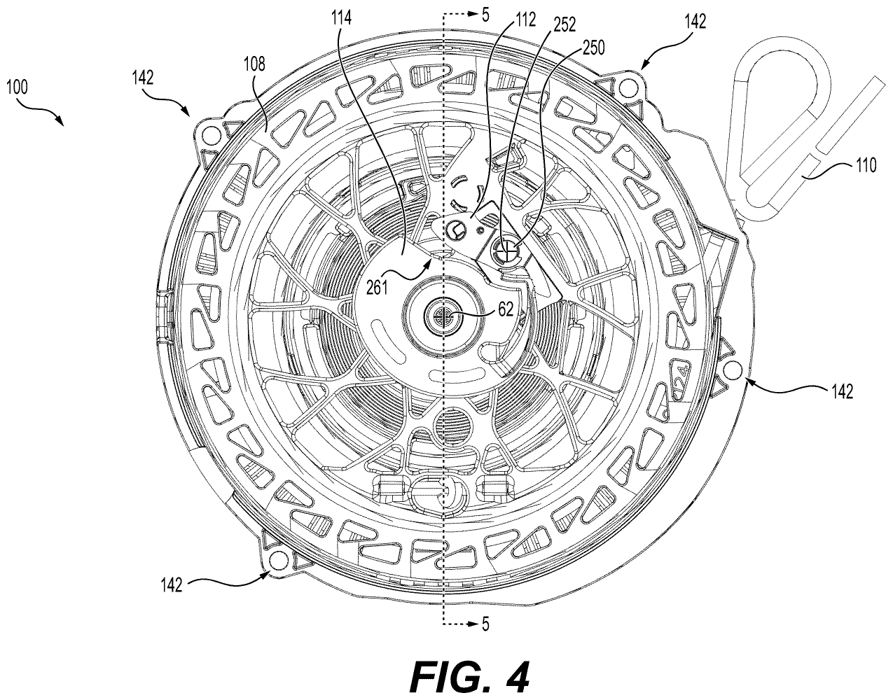

Referring to FIGS. 3 to 10, the damping assembly 102 includes a cover housing 120, a cover mount 122, a damper 124 and a retaining member 126. It is contemplated that the damping assembly 102 could have a different number of parts. It is further contemplated that in some aspects of the present technology, the cover housing 120 and the cover mount 122 could be provided as a single component combining both functions, and may be referred to as a cover.

The cover housing 120 has a housing base 130 and a housing wall 132 that extends axially from the housing base 130.

The housing base 130 defines an aperture 134. As will be described below, the aperture 134 is configured to receive part of the cover mount 122 therethrough. The housing base 130 further has housing connectors 136 that are disposed around the aperture 134. There are five housing connectors 136 in the illustrated embodiment, but it is contemplated that the number of housing connectors 136 could vary. The housing connectors 136 extend partially axially away from the housing wall 132 and partially radially inward thereof. Each one of the housing connectors 136 has a flange 138. It is contemplated that the configuration of the housing connectors 136 may vary. For example, in other embodiments, some of the housing connectors 136 could have flanges while other housing connectors 136 could define recesses.

The housing wall 132 surrounds the housing base 130. It is contemplated that the housing wall 132 could only partially surround the housing base 130. The housing wall 132 defines apertures 142. The apertures 142 are configured to receive fasteners for connecting the cover housing 120, and thus the rewind starter 100, to the engine housing 52. The housing wall 132 also defines a rope aperture 144 that is configured to receive part of the rope 110 therethrough.

The damper 124 is a continuous ring such that the damper 124 may sometimes be referred to as a damping ring 124. As will be described below, the shape and configuration of the damper 124 may vary from one embodiment to another. The damper 124 is sized to extend around the aperture 134 of the housing base 130. As will be described below, the damper 124 is configured to extend on both sides of the housing base 130. It is contemplated that in other embodiments, the damper 124 could only extend on one side of the housing base 130.

The damper 124 has damper positioners 152. There are five damper positioners 152, but it is contemplated that the number of damper positioners 152 may vary from one embodiment to another. Each one of the damper positioners 152 extends in the axial direction. As will be described below, the damper positioners 152 are configured to engage with the cover mount 122.

The damper 124 further has damper connectors 156. There are five damper connectors 156, but it is contemplated that the number of damper connectors 156 may vary from one embodiment to another. Each one of the damper connectors 156 defines a recess 158. As will be described below, the damper connectors 156 are configured to engage with the housing connectors 136 by having the recesses 158 receive corresponding flanges 138.

The damper positioners 152 and the damper connectors 156 are configured in an alternating sequence, such that each damper positioner 152 is disposed between two damper connectors 156, and each damper connector 156 is disposed between two damper positioners 152. It is contemplated that the sequencing of the damper positioners 152 and damper connectors 156 could change.

The damper 124 is made of a resilient material. More specifically, in the present embodiment the damper 124 is made of rubber. It is contemplated that the damper 124 could be made of an elastic material or another material configured to absorb energy.

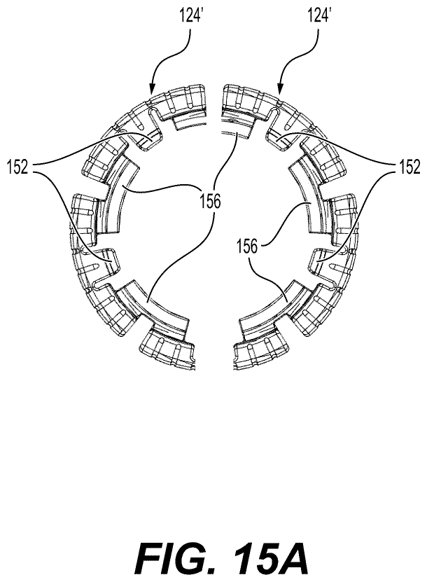

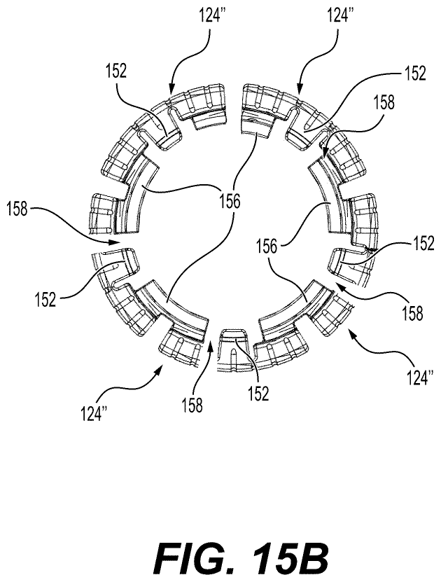

Referring to FIG. 15A, according to an alternative embodiment of the present technology, it is contemplated that instead of having one single damper 124, the damping assembly 102 could have two dampers 124′. Referring to FIG. 15B, and according to yet an other alternative embodiment of the present technology, it is contemplated that the damping assembly 102 could have four dampers 124″. It will be noted that the dampers 124′, 124″ only partially extend around the aperture 134. It is contemplated that in other embodiments, the damper 124 could have three or five or more dampers. The dampers 124′ and 124″ will not be described in more detail herein. However, it should be noted that parts of the dampers 124′ and 124″ that are similar to those of the damper 124 have been labeled with the same reference numerals.

Referring to FIGS. 3 to 6, the cover mount 122 will now be described in greater detail. The cover mount 122 has a mount base 160 and a spindle 162 that extends axially from the mount base 160. When the rewind starter 100 is connected to the engine housing 52, the spindle 162 is coaxial with the crankshaft 60. In the present embodiment, the mount base 160 and the spindle 162 are integral. It is contemplated that in some embodiments, the mount base 160 and the spindle 162 could be made of two or more parts connected to one another. It is contemplated that in other embodiments, the cover mount 122 could consist of a spindle connected to the cover housing 120 via one or more dampers.

The mount base 160 is sized to cover and extend radially beyond an entirety of the aperture 134. The mount base 160 has an axially extending wall 164. The axially extending wall 164 generally defines a circle, and is sized and positioned to fit inside of the aperture 134 of the housing base 130. The axially extending wall 164 defines an opening 166 (FIG. 3). As will be described below, the opening 166 is configured to receive part of the holder 104 therein.

The cover mount 122 has mount connectors 176. There are five mount connectors 176, but it is contemplated that the number of mount connectors 176 may vary from one embodiment to another. Each one of the mount connectors 176 is disposed on the top of the axially extending wall 164. Additionally, each one of the mount connectors 176 extends radially outwardly and radially inwardly. As will be described below, the mount connectors 176 are configured to engage with at least one of the damper 124 and the retaining member 126.

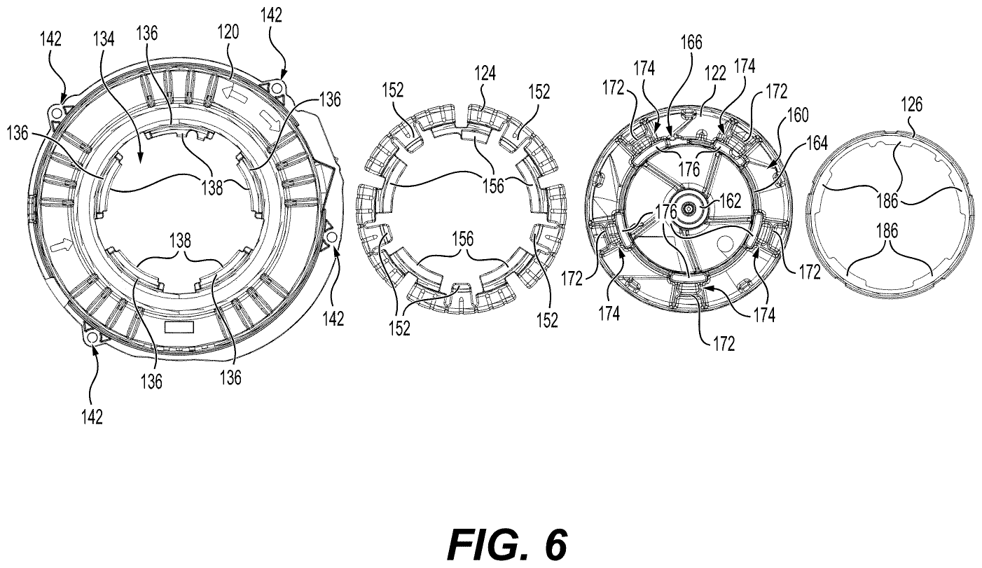

The cover mount 122 additionally has mount positioners 172. There are five mount positioners 172, but it is contemplated that the number of mount positioners 172 may vary from one embodiment to another. Each mount positioner 172 is generally angularly aligned with a corresponding one of the mount connectors 176, and is disposed radially outwardly therefrom. Each one of the mount positioners 172 defines a recess 174 (best seen FIG. 6). As will be described below, the mount positioners 172 are configured to engage with the damper positioners 152. It contemplated that the configuration of the mount positioners 172 may vary. For example, the mount positioner 172 may be a protrusion rather than a recess.

The retaining member 126 is a retaining ring 126, and will henceforth be referred as such. The retaining ring 126 is sized so that an exterior diameter thereof is greater than a diameter of the aperture 134, and so that the inner diameter thereof is smaller than the diameter of the aperture 134. The retaining ring 126 has retaining portions 186 that extend generally radially inwardly. There are five retaining portions 186, but it is contemplated that the number of retaining portions 186 may vary from one embodiment to another.

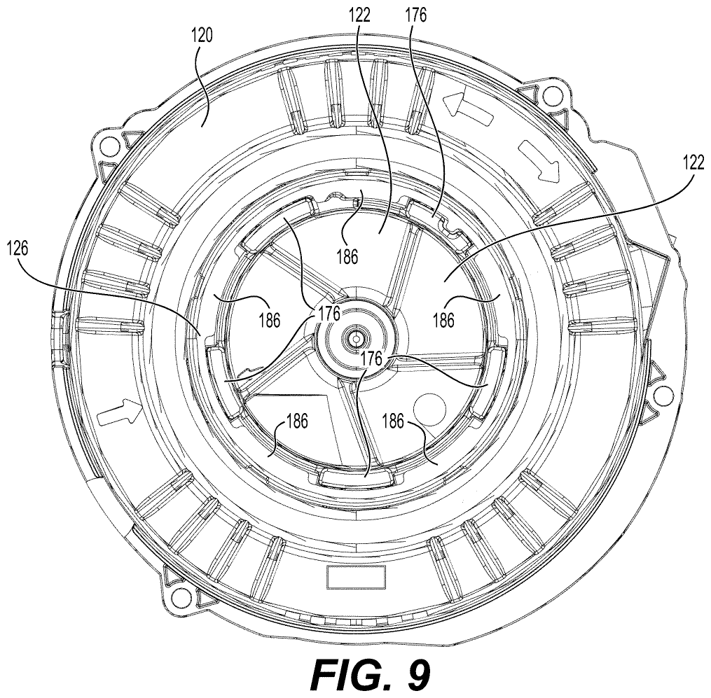

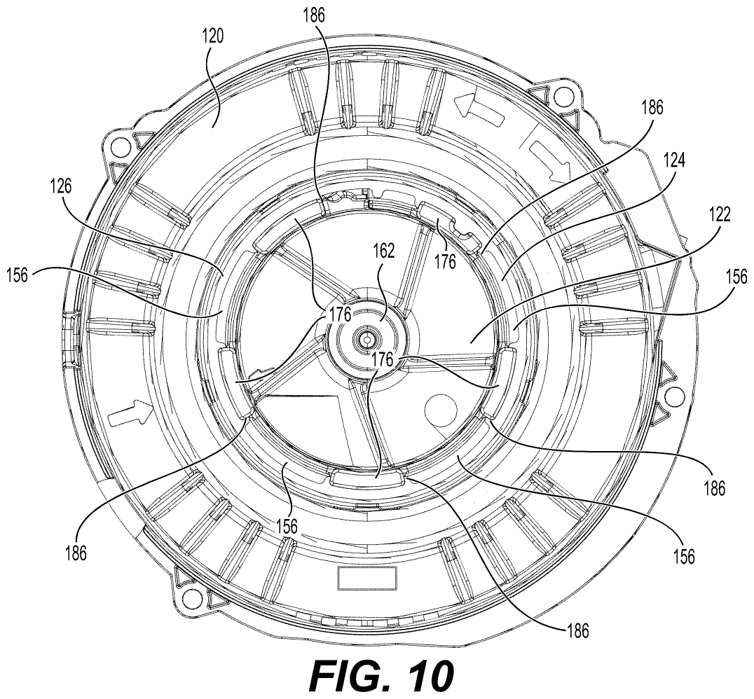

As will be described below, the retaining ring 126 is moveable, with respect to the cover mount 122, between a non-retaining position (FIG. 9) and a retaining position (FIG. 10).

In the non-retaining position, the retaining ring 126 is positioned relative to the cover mount 122 such that the retaining portions 186 are configured to not engage with the mount connectors 176. Thus, the damping assembly 102 can be disassembled.

In the retaining position, the retaining ring 126 is positioned relative to the cover mount 122 such that the retaining portions 186 engage with the mount connectors 176. Thus, disassembly of the damping assembly 102 is prevented.

Referring to FIGS. 3 and 6 to 10, the steps for assembling the damping assembly 102 will now be described in greater detail. It is understood that some of these steps may be performed in a different order.

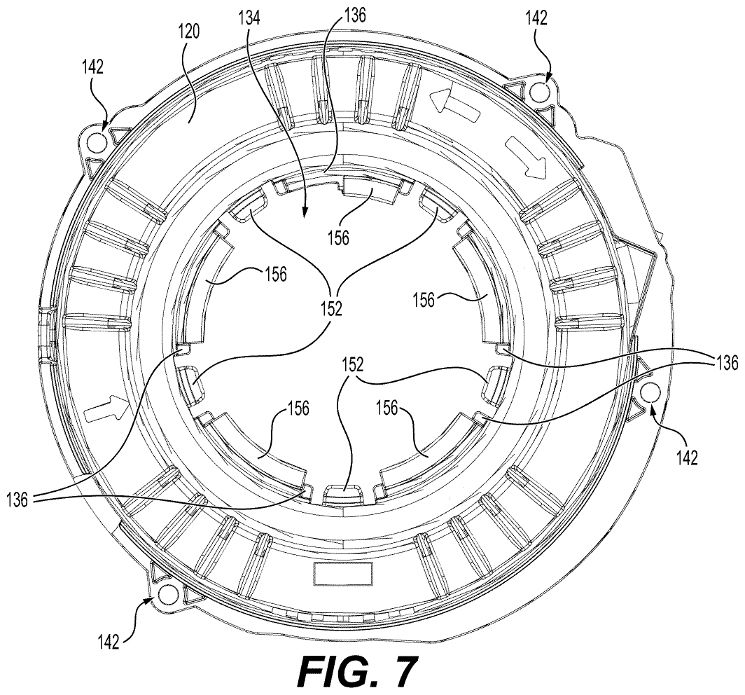

Referring to FIG. 7, the damper 124 is connected to the cover housing 120. This is done by connecting each one of the damper connectors 156 to a corresponding one of the housing connectors 136. More specifically, each flange 138 of each housing connector 136 is received in a corresponding recess 158 of a corresponding damper connector 156. The resilient nature of the damper 124 enables the damper connectors 156 to easily be “folded” over the housing connectors 136.

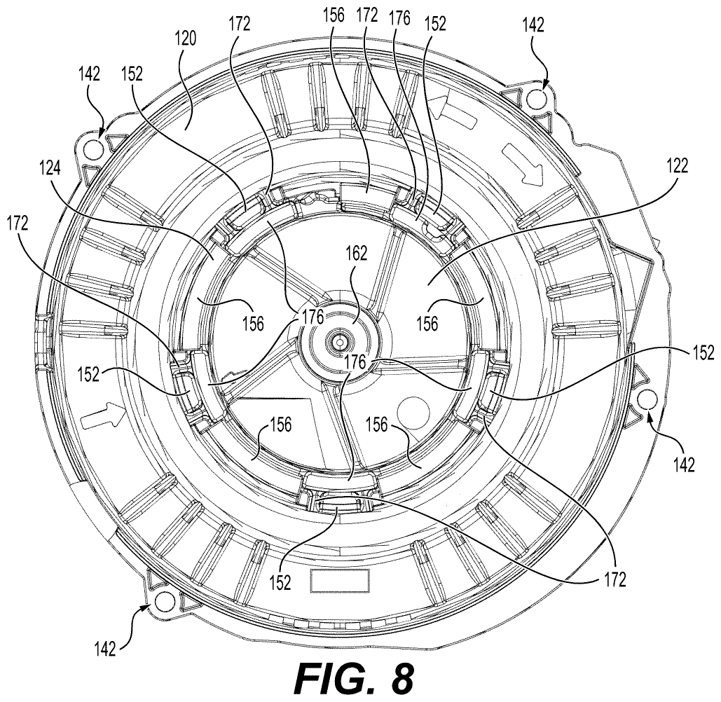

Referring to FIG. 8, the cover mount 122 is connected to the damper 124 via the damper positioners 152 and the mount positioners 172. More specifically, the damper positioners 152 are received in the recesses 174 of the mount positioners 172. The engagement between the damper positioners 152 and the mount positioners 172 can assist in preventing relative movement between the cover mount 122 and the damper 124.

At this point, as best seen in FIG. 8, the mount base 160 covers the aperture 134 from an exterior side of the mount base 160. The spindle 162 is received through the aperture 134. The damper connectors 156 and the mount connectors 176 are disposed in an alternating fashion. Additionally, the damper 124 extends between the cover housing 120 and the cover mount 122.

Referring to FIG. 9, the retaining ring 126 is then moved to the non-retaining position, such that part of the retaining ring 126 abuts an interior surface of the housing base 130 and part of the retaining ring 126 abuts the damper 124. As illustrated, in this position, the retaining portions 186 of the retaining ring 126 are angularly offset from the mount connectors 176.

Referring to FIG. 10, once the retaining ring 126 is in the non-retaining position, the retaining ring 126 can be rotated to the retaining position. In the retaining position, the retaining portions 186 of the retaining ring 126 are angularly aligned with the mount connectors 176. More specifically, the retaining portions 186 are partially disposed between the damper 124 and the cover mount 122, thereby retaining the damping assembly 102 together.

It will be appreciated that the cover housing 120, the cover mount 122, the damper 124 and the retaining ring 126 are, as described above, selectively connected to one another. It is contemplated however, that some components may be permanently connected to one another. For example, in some embodiments, the damper 124 may be overmolded to one of the cover housing 120 and the cover mount 122.

The damping assembly 102 is configured such that when it is connected to the engine housing 52, the cover housing 120 is directly connected to the engine housing 52, and is therefore subjected to all vibrations when the engine 50 is running. However, the damper 124 is disposed between the cover housing 120 and the cover mount 122, such that the damper 124 damps vibrations between the cover housing 120 and the cover mount 122. Therefore, parts of the rewind starter 100 which are mounted on the cover mount 122 are subjected to less vibrations.

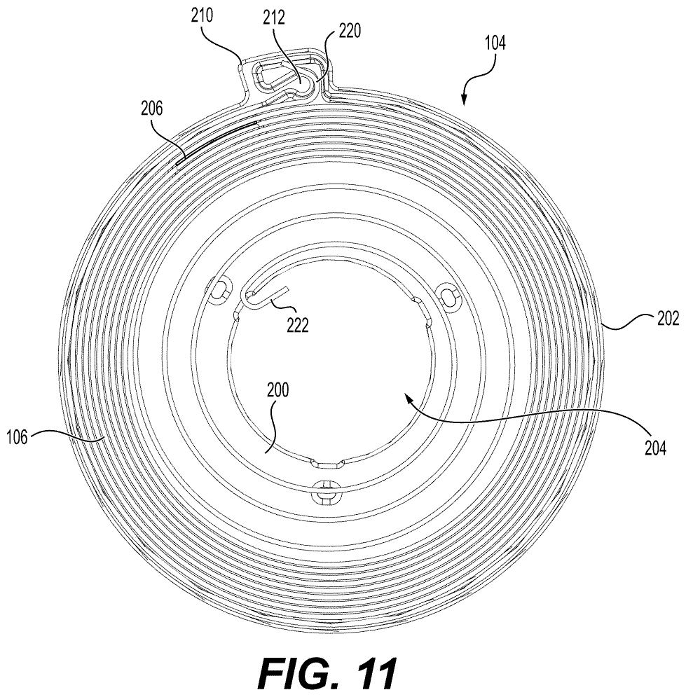

Referring to FIGS. 3 and 11, the holder 104 will now be described in greater detail. The holder 104 has a holder base 200 and a holder wall 202 extending axially from the holder base 200.

The holder base 200 defines a central aperture 204 that is configured to receive the spindle 162 therethrough.

A guiding projection 206 extends axially from the holder base 200. The guiding projection 206 is disposed between the holder wall 202 and the central aperture 204. More specifically, the guiding projection 206 is disposed closer to the holder wall 202 than the central aperture 204. It is contemplated that in other embodiments, there could be two or more guiding projections 206. As will be described in greater detail below, the guiding projection 206 is configured to extend between windings of the recoil spring 106.

The holder wall 202 surrounds the holder base 200. In some embodiments, the holder wall 202 could only partially surround the holder base 200. The holder wall 202 has a radially extending section 210. The radially extending section 210 has a radially outer hooking portion 212. As will be described below, the radially outer hooking portion 212 is configured to hook with the recoil spring 106. As will also be described below, the radially extending section 210 is sized and shaped to be received in the opening 166 of the axially extending wall 164.

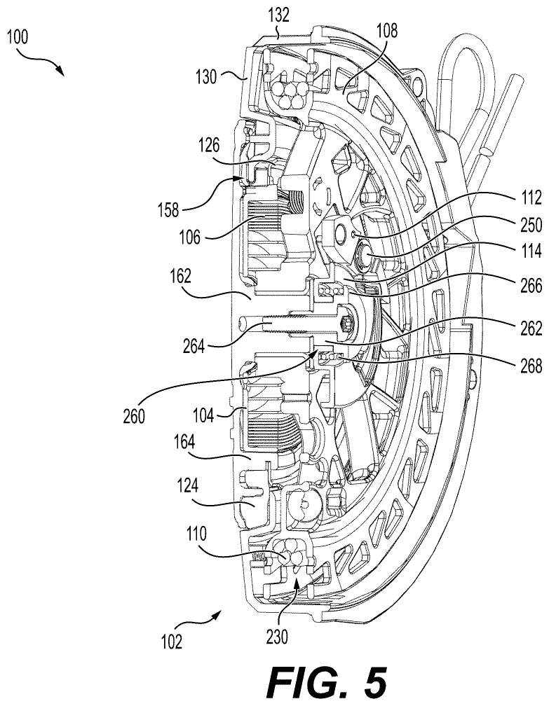

Thus, when connecting the holder 104 to the damping assembly 102, the radially extending section 210 is received in the opening 166, thereby resulting in the holder 104 being rotationally fixed relative to the cover mount 122. Additionally, as best seen in FIG. 5, the holder wall 202 abuts against the damper 124. The damper 124 may deform which can assist the holder 104 in remaining in position relative to the damping assembly 102.

Still referring to FIGS. 3 and 11, the recoil spring 106, which has a plurality of windings, is received in the holder 104. The recoil spring 106 is operatively connected to the holder 104 and to the sheave 108. More specifically, a radially outer end 220 of the outermost winding of the recoil spring 106 is connected to the radially outer hooking portion 212, and a radially inner end 222 of the innermost winding of the recoil spring 106 is connected to the sheave 108. Thus, as will be described later, the recoil spring 106 is configured to bias the sheave 108 towards a rest position.

The recoil spring 106 is positioned in the holder 104, and the holder 104 is configured such that, the guiding projection 206 is disposed between the outermost winding and the second outermost winding of the recoil spring 106. It is contemplated that the guiding projection 206 could be disposed elsewhere. For example, the guiding projection 206 may be disposed between the second and third outermost windings, or between the third and fourth outermost windings.

The recoil spring 106 being positioned in the holder 104 can assist in reducing the vibration that the recoil spring 106 is subjected to, which can extend the life of the recoil spring 106. Also, the recoil spring 106 being positioned in the holder 104 can reduce wear that the recoil spring 106 and the cover mount 122 would otherwise be subjected to due to relative movement and friction therebetween. The presence of the guiding projection 206 can assist in keeping the recoil spring 106 generally centered, which can also extend its life by limiting undue deformation thereof. Additionally, the presence of the guiding projection 206 between the outermost and second outermost windings provides a dampening effect, which can reduce movement of the recoil spring 106 caused by engine vibrations. This can also extend life of the recoil spring 106.

Referring to FIGS. 3 to 5, the sheave 108 is mounted to the spindle 162 such that the sheave 108 is rotatable about the spindle 162. Thus, when the rewind starter 100 is connected to the engine housing 52, the sheave 108 is rotatable about the axis 62. The sheave 108 defines a groove 230 in which part of the rope 110 is received. The rope 110 is wound around the sheave 108. One end of the rope 110 is connected to the sheave 108 such that when the rope 110 is pulled, the sheave 108 is caused to rotate about the axis 62. An other end of the rope 110, which, when the rewind starter 100 is fully assembled, is received through the rope aperture 144, is configured to connect to a handle (not shown). The handle could be configured to be larger than the rope aperture 144. Alternatively, the rope 110 could be provided with a stopper to prevent the end of the rope 110 to enter inside the rewind starter 100.

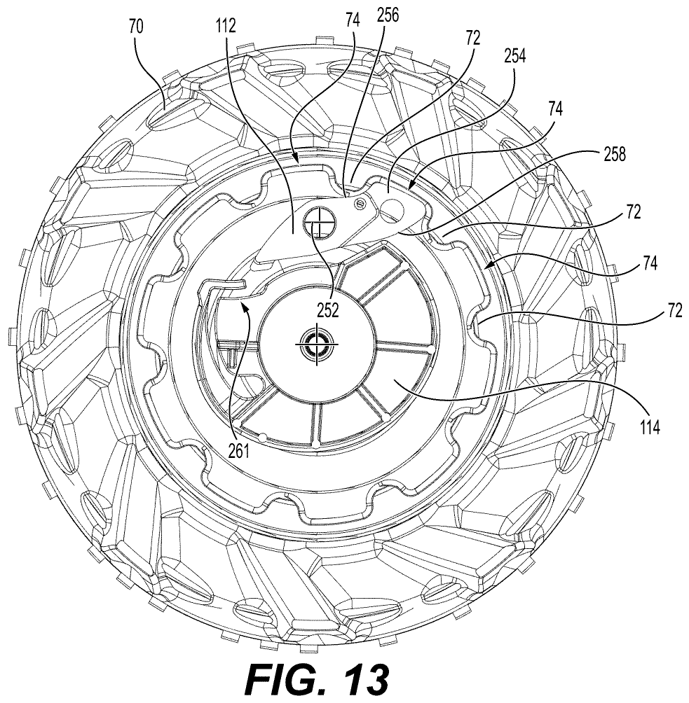

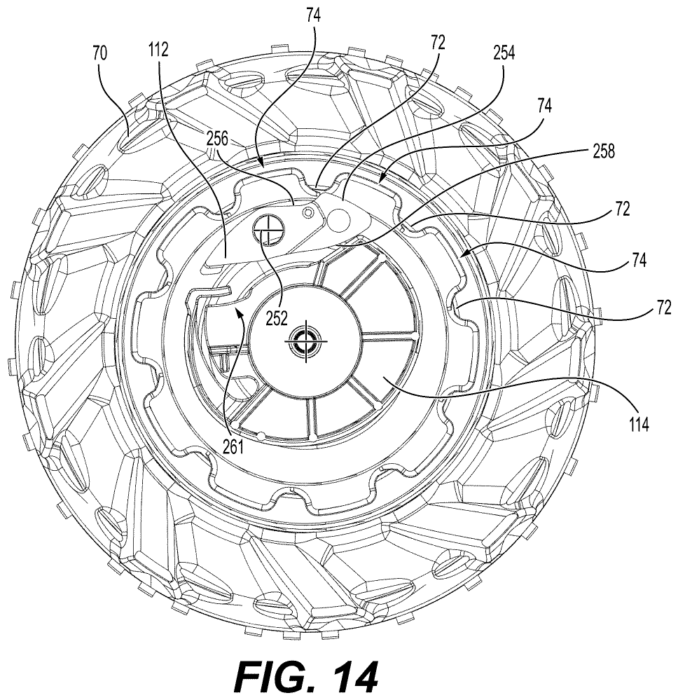

Referring to FIGS. 3, 4, 5 and 12 to 14, the pawl 112 is pivotally connected to the sheave 108 via a pivot 250. As will be described below, the pawl 112 is pivotable relative to the sheave 108 about a pivot axis 252 between a disengaged position (FIG. 12), an engaged position (FIG. 13) and a neutral position (FIG. 14).

The pawl 112 has a driving portion 254 that is sized and shape to be received in the flywheel recesses 74, and that can drivingly engage with the flywheel teeth 72.

The pawl 112 has an arcuate surface 256 extending on one side of the driving portion 254. As will be described below, the shape of the arcuate surface 256 can enable the pawl 112 to move between the engaged and neutral positions.

The pawl 112 has an abutting surface 258 extending on a side of the pawl 112 that is opposite the side having the driving portion 254. As will also be described below, the abutting surface 258 is configured to abut against the lock lever 114, and therefore cause the pawl 112 to change positions.

Referring to FIG. 12, the pawl 112 is in the disengaged position. The pawl 112 is in the disengaged position when the sheave 108 is its rest position. When the pawl 112 is in the disengaged position, the pawl 112 is spaced from the flywheel 70, such that the pawl 112 does not engage the flywheel teeth 72.

Referring to FIG. 13, the pawl 112 is in the engaged position. As will be described in greater detail below, the pawl 112 is in the engaged position when the sheave 108 is rotated by pulling on the rope 110 to pull-start the engine 50. When the pawl 112 is in the engaged position, the pawl 112 is in driving engagement with the flywheel 70. Thus, the driving portion 254 is received in one of the flywheel recesses 74, and engages with one of the flywheel teeth 72. The shape of the arcuate surface 256 provides enough clearance so as to not abut with one of the flywheel teeth 72.

Referring to FIG. 14, the pawl 112 is in the neutral position. As will be described in greater detail below, the pawl 112 is in the neutral position when the sheave 108 is rotating slower than the flywheel 70 or when the sheave 108 and the flywheel 70 are rotating in opposite directions. The neutral position is intermediate to the engaged and disengaged positions. When the pawl 112 is in the neutral position, the shape of the arcuate surface 256 enables the pawl 112 to slide over the flywheel teeth 72 without the pawl 112 getting in driving engagement therewith.

Referring back to FIGS. 3 and 5, the lock lever 114 has a disc-like shape with a recessed section 261. Additionally, the lock lever 114 defines an aperture 260 extending in the axial direction. A sleeve 262 is received in the aperture 260. The sleeve 262 is fastened to the cover mount 122 via a fastener 264. The sleeve 262 has a flange 266. A spring 268 is disposed between the flange 266 and the lock lever 114. The spring 268 is in a preloaded state, such that the flange 266 is pressed upon the cover mount 122, resulting in the presence of frictional forces therebetween. Thus, when the sheave 108 rotates, the lock lever 114 remains generally fixed to the cover mount 122 due to the frictional forces, until the pawl 112 abuts the lock lever 114. As will be described below, the engagement between the pawl 112 and the lock lever 114 can cause the lock lever 114 to rotate.

Once the rewind starter 100 is assembled, as described hereabove, the rewind starter 100 can be connected to the engine housing 52 by inserting fasteners into the apertures 142. A description of the rewind starter 100 in operation will now be provided.

When the engine 50 is not running, the rewind starter 100 can be used to start the engine 50.

The sheave 108 is caused to rotate about the spindle 162 by pulling on the rope 110 via the handle (not shown). The pawl 112 is connected to the sheave 108, and thus rotates therewith, whereas the lock lever 114 does not move with respect to the cover mount 120 due to the frictional force caused by the spring 268, as described hereabove. Eventually, after crossing the recessed section 261, the abutting surface 258 abuts the lock lever 114. The frictional force of the lock lever 114 causes the pawl 112 to move to the engaged position in which, as mentioned above, the driving portion 254 is received in one of the flywheel recesses 74.

At this point, the sheave 108 and the flywheel 70 are drivingly engaged to one another. Since the flywheel 70 is connected to the crankshaft 60, rotation of the sheave 108 causes rotation of the flywheel 70. This, in turn, causes the crankshaft 60 to rotate such that the pistons move within the cylinders. A spark plug (not shown) creates a spark causing ignition of an air-fuel mixture present within the cylinders. The engine 50 has thus been started.

As the sheave 108 is rotating, the recoil spring 106 is winding up. When the handle (not shown) is released, for example when the engine has started, the recoil spring 106 biases the sheave 108 back towards the rest position causing the rope 110 to wind back around the sheave 108.

When the engine 50 is running, the crankshaft 60 and the flywheel 70 are rotating, the sheave 108 is in rest position, and the pawl 112 is in the disengaged position, such that the sheave 108 and the flywheel 70 are drivingly disconnected from one another.

If the rope 110 were to be pulled, the sheave 108 would rotate. As described above, the pawl 112 would be guided toward the engaged position. However, due the relative speed between the flywheel 70 and the sheave 108, the pawl 112 moves to the neutral position due to the arcuate surface 256, which is shaped to slide over the flywheel teeth 72.

When the flywheel 70 and the sheave 108 rotate in opposite directions, the arcuate surface 256 does not contact the flywheel teeth 72. Engagement between the pawl 112 and the flywheel 70 is prevented due to the length of the driving portion 254. Even in during idle operation, the flywheel 70 rotates significantly faster, for example at least five times faster, than the sheave 108 can be pulled, and with the length of the driving portion 254 relative to a length of the flywheel recesses 74, there is not enough time for the pawl 112 to engage with the flywheel 70. Also, the driving portion 254 is rounded such that it slips over the flywheel teeth 72. The pawl 112 moves to the neutral position due to the arcuate surface 256, which is shaped to slide over the flywheel teeth 72.

Modifications and improvements to the above-described embodiments of the present technology may become apparent to those skilled in the art. The foregoing description is intended to be exemplary rather than limiting. The scope of the present technology is therefore intended to be limited solely by the appended claims.

What is claimed is:

1. A damping assembly for a rewind starter of an engine, the damping assembly comprising:
a cover housing configured to connect to a housing of the engine, the cover housing including:
a housing base defining an aperture; and
a housing wall extending axially from the housing base, the housing wall at least partially surrounding the housing base,
at least one damper connected to the housing base, the at least one damper extending at least partially around the aperture;
a cover mount connected to the at least one damper, the cover mount at least partially extending through the aperture, the cover mount at least partially covering the aperture, and the cover mount having a spindle configured to operatively connect to part of the rewind starter; and
a retaining member retaining the cover housing, the at least one damper and the cover mount together.

2. The damping assembly of claim 1, wherein at least one of:
the at least one damper is selectively connected to the housing base; and
the cover mount is selectively connected to the at least one damper.

3. The damping assembly of claim 1, wherein:
the cover housing has housing connectors; and
the at least one damper has damper connectors, each one of the damper connectors being engaged to a corresponding one of the housing connectors.

4. The damping assembly of claim 3, wherein:
each one of the housing connectors has a flange, and
each one of the damper connectors defines a recess receiving the flange of a corresponding one of the housing connectors.

5. The damping assembly of claim 1, wherein the cover mount has mount connectors engaged with at least one of the at least one damper and the retaining member.

6. The damping assembly of claim 1, wherein:
the at least one damper has damper positioners; and
the cover mount has mount positioners, each one of the mount positioners being engaged with a corresponding one of the damper positioners for positioning the at least one damper relative to the cover mount.

7. The damping assembly of claim 1, wherein the at least one damper is made of a resilient material.

8. The damping assembly of claim 7, wherein the resilient material is rubber.

9. The damping assembly of claim 1, wherein the at least one damper is two dampers.

10. The damping assembly of claim 1, wherein the at least one damper is a damping ring.

11. The damping assembly of claim 1, wherein the retaining member is a retaining ring.

12. The damping assembly of claim 1, wherein the retaining member is moveable between:
a retaining position, in which the cover housing, the at least one damper and the cover mount are retained together; and
a non-retaining position, in which the cover housing, the at least one damper and the cover mount are free to be moved away from one another.

13. The damping assembly of claim 12, wherein the retaining member is moveable between the retaining position and the non-retaining position by rotation.

14. A rewind starter for an engine, the rewind starter comprising:
the damping assembly of claim 1;
a sheave rotationally connected to the spindle, the sheave having a rest position;
a rope wound around the sheave;
a recoil spring operatively connected to the damping assembly and operatively connected to the sheave, the recoil spring biasing the sheave toward the rest position;
a pawl pivotally connected to the sheave, the pawl being pivotable about a pivot axis between:
an engaged position, in which the pawl is configured to be drivingly engaged to a flywheel of the engine; and
a disengaged position, in which the pawl is configured to be drivingly disengaged from the flywheel of the engine; and
a lock lever operatively connected to the spindle, the lock lever being configured to cause the pawl to move between the engaged position and the disengaged position.

15. The rewind starter of claim 14, wherein:
the recoil spring has a plurality of windings, and
the rewind starter further comprises a holder holding the recoil spring, the holder comprising:
a holder base defining a central aperture for receiving the spindle therethrough;
a holder wall extending axially from the holder base, the holder wall at least partially surrounding the holder base; and
a guiding projection extending axially from the holder base, the guiding projection being positioned axially between the holder wall and the central aperture, between two windings of the plurality of windings.

16. The rewind starter of claim 15, wherein the two windings of the plurality of windings are a radially outermost winding and a second radially outermost winding.

17. The rewind starter of claim 15, wherein:
the recoil spring has a radially outer end and a radially inner end;
the holder wall defines a radially outer hooking portion;
the radially outer end is connected to the radially outer hooking portion; and
the radially inner end is connected to the sheave.

18. The rewind starter of claim 14, wherein:
in the disengaged position, the pawl is spaced from the flywheel; and
the pawl is further moveable to a neutral position, in the neutral position the pawl is configured to be non-drivingly engageable to the flywheel.

19. The rewind starter of claim 18, wherein the neutral position is intermediate to the engaged position and to the disengaged position.

20. The rewind starter of claim 18, wherein the pawl has an arcuate edge, and with the pawl being in the neutral position, the arcuate edge is configured to slide over engaging portions of the flywheel.
